(19) United States
(12) Patent Application Publication
(10) Pub. No.: US 2026/0107925 A1
(43) Pub. Date: Apr. 23, 2026

(54) BIOMETRIC SCANNING SYSTEM FOR LIVESTOCK

(71) Applicant: M3SEN Co., Ltd., Seoul (KR)

(72) Inventors: Man Hyeong SEO, Bucheon-si (KR); Jung Woon LEE, Gunpo-si (KR)

(21) Appl. No.: 19/266,458

(22) Filed: Jul. 11, 2025

(30) Foreign Application Priority Data
Oct. 17, 2024 (KR) 10-2024-0142487

(51) Int. Cl. A01K 29/00

(52) U.S. Cl. CPC A01K 29/002

(57) ABSTRACT

A biometric scanning system for livestock according to one or more embodiments of the present disclosure may include: a cage member configured to accommodate livestock; a rail member disposed above the cage member; a moving member disposed at the rail member and configured to move along a longitudinal direction D1 of the rail member; a scanner connected to the moving member and configured to measure biometric information of the livestock; and a driving unit configured to move the moving member and a cable connected to the scanner along the longitudinal direction D1.

This application claims benefit and priority of Korean patent application No. 10-2024-0142487 filed Oct. 17, 2024, which is incorporated herein by reference.

### BACKGROUND

### 1. Technical Field

The present disclosure relates to a biometric scanning system for livestock, and more particularly, to a biometric scanning system for livestock that is capable of collecting biometric information such as body condition score (BCS), body temperature, body weight, and backfat thickness of a plurality of livestock.

### 2. Related Art

In the livestock field, it is important to measure biometric data such as body weight, body shape, body temperature, backfat thickness, and body condition score (BCS) of livestock. This is because the results of such measurements determine the amount of feed to be provided and whether the livestock is affected by disease. In addition, obtaining these measurements is essential for ensuring the productivity of livestock farms. Accordingly, various measurement methods and devices are used in the livestock field. However, most of the conventional methods and devices require manual measurement by a worker.

When a worker manually measures the body weight, body shape, body temperature, backfat thickness, and body condition score of livestock, the process relies on visual inspection or handheld measuring devices. As a result, frequently monitoring hundreds of animals at short intervals requires significant manpower and a large amount of working time.

In addition, due to aging populations and declining rural populations, the availability of skilled labor in the domestic livestock industry is decreasing. Therefore, when workers manually measure livestock's body weight, body shape, body temperature, backfat thickness, and body condition score, it may lead to reduced work efficiency and productivity.

In this context, smart systems have recently been increasingly applied to the livestock industry. However, when implementing such systems, installing a large number of devices on a farm may complicate the farm structure, increase installation costs, and make maintenance more difficult.

### SUMMARY

The present disclosure aims to address the aforementioned problems and other related issues. One of the technical objectives of certain embodiments of the present disclosure is to provide a biometric scanning system for livestock that is capable of collecting biometric information such as body condition score (BCS), body temperature, body weight, and backfat thickness from a plurality of livestock.

Another objective is to provide a biometric scanning system for livestock that is implemented with a simple structure so as not to complicate the farm layout, while also enhancing cost efficiency in system installation and facilitating ease of maintenance.

The technical objectives to be achieved by the present disclosure are not limited to those mentioned above, and other technical objectives not explicitly stated will be clearly understood by those skilled in the art from the following description.

According to some embodiments of the present disclosure, a biometric scanning system for livestock may include: a cage member configured to accommodate livestock; a rail member disposed above the cage member; a moving member disposed at the rail member and configured to move along a longitudinal direction D1 of the rail member; a scanner connected to the moving member and configured to measure biometric information of the livestock; and a driving unit configured to move the moving member and a cable connected to the scanner along the longitudinal direction D1.

According to some embodiments of the present disclosure, the driving unit may include: a control box connected to an end of the rail member and having a box hole in communication with an interior of the rail member, the control box being configured to house a controller connected to the cable; a first transfer unit disposed inside the control box and the rail member, and configured to move the moving member along the longitudinal direction D1; and a second transfer unit disposed inside the rail member, connected to the moving member, and configured to move a cable connected between the controller and the scanner along the longitudinal direction D1.

According to some embodiments of the present disclosure, the first transfer unit may include: a motor disposed inside the control box; a first driving pulley disposed inside the control box and connected to a drive shaft of the motor; a second driving pulley disposed inside the rail member; and a timing belt connected in the form of caterpillar tracks between the first driving pulley and the second driving pulley, and a belt link portion of the moving member may be coupled to the timing belt.

According to some embodiments of the present disclosure, the rail member may include: a rail body; a linear room formed inside the rail body, in which the moving member is disposed; a rail wall portion protruding inward from an interior of the rail body; an upper belt room formed inside the rail body and configured to receive an upper timing belt, which is an upper portion of the timing belt having the form of caterpillar tracks; and a lower belt room recessed in a width direction D2 into the rail wall portion and configured to receive a lower timing belt, which is an lower portion of the timing belt having the form of caterpillar tracks, wherein the lower belt room is disposed below the upper belt room, and the belt link portion may be inserted into the lower belt room.

According to some embodiments of the present disclosure, the first transfer unit may further include: a position adjustment unit disposed inside the control box and configured to adjust a vertical position of the timing belt, and the position adjustment unit may be configured to adjust the vertical position of the timing belt to prevent the timing belt from contacting the upper belt room and the lower belt room, respectively.

According to some embodiments of the present disclosure, the position adjustment unit may include: a position adjustment hole formed through the control box in a vertical direction D3; a position adjustment block disposed at the position adjustment hole; a position adjustment fastener configured to adjust a vertical position of the position adjustment block on the position adjustment hole; a first adjustment pulley disposed on the position adjustment block and configured to support the upper timing belt; and a second adjustment pulley disposed below the first adjustment pulley on the position adjustment block and configured to support the lower timing belt.

According to some embodiments of the present disclosure, the first transfer unit may further include: a tension adjustment unit disposed inside the control box and configured to adjust tension of the timing belt.

According to some embodiments of the present disclosure, the tension adjustment unit may include: a tension adjustment hole formed through the control box in a vertical direction D3; a tension adjustment block disposed at the tension adjustment hole; a tension adjustment fastener configured to adjust a vertical position of the tension adjustment block within the tension adjustment hole; and a tension adjustment pulley disposed on the tension adjustment block and configured to apply tension to the timing belt, and the tension adjustment pulley may move in the vertical direction D3 to adjust the tension of the timing belt.

According to some embodiments of the present disclosure, the second transfer unit may include: a carrier chain configured to move the cable along the longitudinal direction D1, wherein one end of the carrier chain is coupled to a chain link portion of the moving member, and the other end of the carrier chain may be fixed to a bottom surface of the linear room.

According to some embodiments of the present disclosure, the carrier chain may include: a chain body including a first chain piece in which a link hole is formed, and a second chain piece in which a link protrusion is formed; a first chain coupling portion connected to the chain body and coupled to the chain link portion; a second chain coupling portion connected to the chain body and coupled to a bottom surface of the linear room; a plurality of cable fixing beams connected to an end of the second chain coupling portion and extending along the longitudinal direction D1, the plurality of cable fixing beams being arranged at predetermined intervals along a width direction D2; a cable fixing hole formed between the plurality of cable fixing beams; and a cable fixing protrusion protruding in the width direction D2 from an end of each of the plurality of cable fixing beams, wherein the cable passes through the cable fixing hole, and the cable fixing protrusion presses an upper portion of the cable so that the cable is in close contact with the bottom surface of the linear room.

The technical solutions achievable by the present disclosure are not limited to those described above, and other solutions not explicitly mentioned will be clearly understood by those skilled in the art from the following description.

The effects of the biometric scanning system for livestock according to the present disclosure are as follows.

According to some embodiments of the present disclosure, biometric information such as body condition score (BCS), body temperature, body weight, and backfat thickness of a plurality of livestock can be collected quickly and accurately. This allows real-time monitoring of the condition of multiple animals, enabling prompt treatment, prevention, or other actions in cases where specific animals are affected by disease.

According to some embodiments of the present disclosure, it is possible to easily determine whether specific livestock have reached their rearing targets. This can assist in setting additional rearing plans, shipping schedules, and the like.

According to some embodiments of the present disclosure, a smart system can be implemented on a farm with a relatively simple structure. This can prevent the farm from becoming overly complex, enhance the cost-effectiveness of system installation, and facilitate easier maintenance.

According to some embodiments of the present disclosure, biometric information of livestock can be recognized in a non-contact manner, thereby minimizing stress on the animals.

The effects achievable by the present disclosure are not limited to those mentioned above, and other effects not explicitly stated will be clearly understood by those skilled in the art from the following description.

### BRIEF DESCRIPTION OF THE DRAWINGS

Various embodiments of the present disclosure are described with reference to the drawings, in which like reference numerals are used collectively to refer to similar components. In the following embodiments, numerous specific details are provided for the purpose of facilitating a comprehensive understanding of one or more embodiments. However, it will be apparent that such embodiments may be implemented without these specific details.

FIG. 1 is a perspective view illustrating a biometric scanning system for livestock according to some embodiments of the present disclosure.

FIG. 2A is a front view illustrating a driving unit and a rail member according to some embodiments of the present disclosure.

FIG. 2B is a front view illustrating an interior of a control box according to some embodiments of the present disclosure.

FIG. 2C is a rear perspective view illustrating an interior of a control box according to some embodiments of the present disclosure.

FIG. 2D is a view illustrating a structure of first and second transfer units disposed inside a rail member and a control box according to some embodiments of the present disclosure.

FIG. 3 is a cross-sectional view illustrating the section A-A′ shown in FIG. 2A.

FIG. 4A is a perspective view illustrating a moving member according to some embodiments of the present disclosure.

FIG. 4B is a front view illustrating a moving member according to some embodiments of the present disclosure.

FIG. 4C is a side view illustrating a moving member according to some embodiments of the present disclosure.

FIG. 4D is a plan view illustrating a moving member according to some embodiments of the present disclosure.

FIG. 5 is a view illustrating a coupled state between a moving member and a scanner according to some embodiments of the present disclosure.

FIG. 6A is a view illustrating a coupling structure between a moving member and a first chain coupling portion of a carrier chain according to some embodiments of the present disclosure.

FIG. 6B is a view illustrating a coupling structure between a second chain coupling portion of a carrier chain and a bottom surface of a linear room according to some embodiments of the present disclosure.

FIG. 7 is a cross-sectional view illustrating the section B-B′ shown in FIG. 2A.

FIG. 8A is a perspective view illustrating a height adjustment member according to some embodiments of the present disclosure.

FIG. 8B is a front view illustrating a height adjustment member according to some embodiments of the present disclosure.

FIG. 8C is a side view illustrating a height adjustment member according to some embodiments of the present disclosure.

FIG. 8D is a cross-sectional view illustrating the section C-C′ shown in FIG. 8C.

FIG. 9 is a view illustrating a state in which a biometric scanning system for livestock scans biometric information of livestock according to some embodiments of the present disclosure.

### DETAILED DESCRIPTION

Hereinafter, various embodiments of a printing apparatus according to the present disclosure will be described in detail with reference to the drawings. The same reference numerals will be assigned to identical or similar components regardless of the drawing figures, and redundant descriptions thereof will be omitted.

The objects and effects of the present disclosure, as well as the technical configurations for achieving them, will become apparent with reference to the embodiments described in detail below in conjunction with the accompanying drawings. In describing one or more embodiments of the present disclosure, detailed descriptions of well-known technologies may be omitted when it is determined that such descriptions could obscure the essence of at least one embodiment of the present disclosure.

The terms used in the present disclosure are defined in consideration of the functions of the present disclosure, and may vary depending on the intention or customary usage of users or operators. In addition, the accompanying drawings are provided solely to facilitate understanding of one or more embodiments of the present disclosure, and are not intended to limit the technical spirit of the present disclosure. It should be understood that all modifications, equivalents, and substitutes that fall within the spirit and scope of the present invention are included.

In the following description, the suffixes “module” and “unit” used for components are assigned or used interchangeably merely for convenience in drafting the present disclosure, and do not have distinct meanings or functions in themselves.

Terms including ordinal numbers such as “first” and “second” may be used to describe various components, but such components are not limited by these terms. These terms are used only to distinguish one component from another. Therefore, a first component described below may be referred to as a second component within the technical spirit of the present disclosure.

When a component is referred to as being “connected” or “coupled” to another component, it should be understood that the component may be directly connected or coupled to the other component, or may be indirectly connected or coupled via one or more intermediate components. In contrast, when a component is referred to as being “directly connected” or “directly coupled” to another component, it should be understood that there are no intermediate components between them.

Unless clearly stated otherwise in context, the singular forms used herein include the plural forms as well. That is, unless otherwise specified or clearly indicated by context, the singular form in the present disclosure and the claims should be interpreted as meaning “one or more.”

In the present disclosure, the terms “comprise,” “comprises,” “having,” and the like are intended to specify the presence of stated features, numerals, steps, operations, components, parts, or combinations thereof, but are not intended to preclude the presence or addition of one or more other features, numerals, steps, operations, components, parts, or combinations thereof.

In the present disclosure, the term “or” is to be understood as having an inclusive meaning rather than an exclusive meaning. That is, unless otherwise specified or clearly indicated by context, the phrase “X uses A or B” is intended to mean any of the following: X uses A; X uses B; or X uses both A and B. In addition, the term “and/or” as used in the present disclosure is to be understood as encompassing all possible combinations of one or more of the listed items.

Unless otherwise defined, all terms (including technical and scientific terms) used in the present disclosure shall have the meanings commonly understood by those skilled in the art to which the present disclosure pertains. Terms that are generally defined in commonly used dictionaries shall be interpreted as having meanings consistent with their ordinary usage and shall not be interpreted in an overly narrow or broad sense unless specifically defined herein.

However, the present disclosure is not limited to the embodiments set forth below, but may be implemented in various other forms. The embodiments of the present disclosure are merely provided to fully convey the scope of the present disclosure to those skilled in the art. The present disclosure is defined only by the scope of the claims, and thus the definitions should be made based on the entire content of the present disclosure.

Hereinafter, a first direction D1 may be defined as the same direction as a longitudinal direction of components such as the rail member 200 and the moving member 300, a second direction D2 may be defined as the same direction as a width direction of the rail member 200 and the moving member 300, and a third direction D3 may be defined as the same direction as a vertical direction of the rail member 200 and the moving member 300.

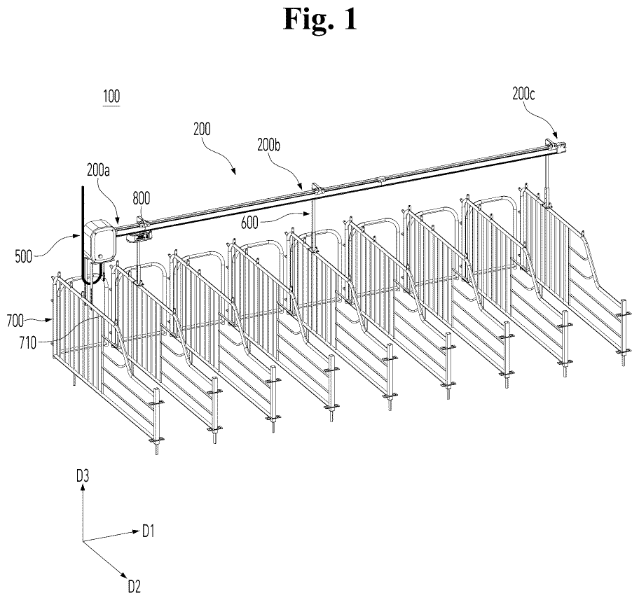

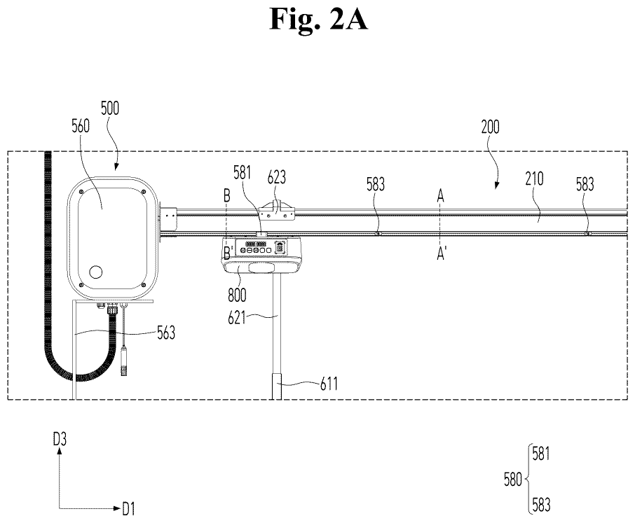

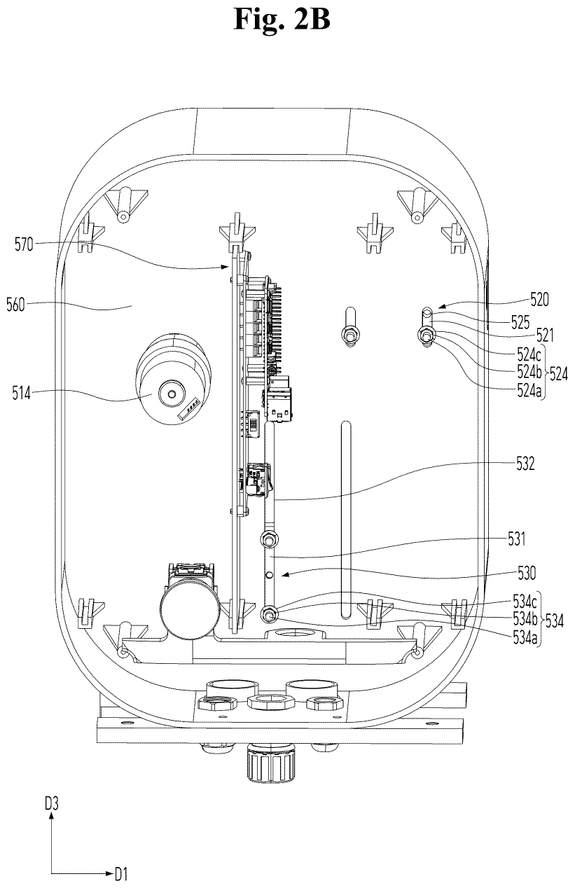

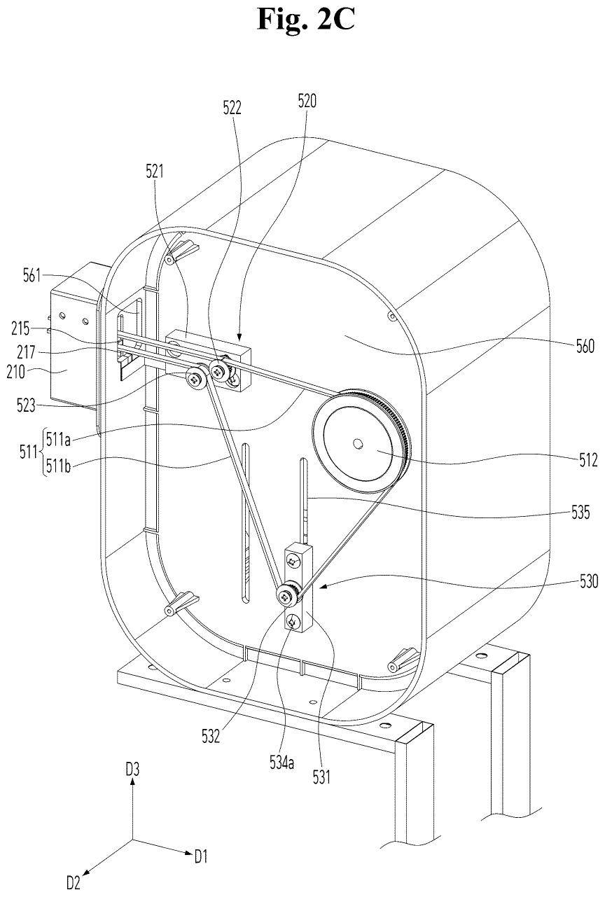

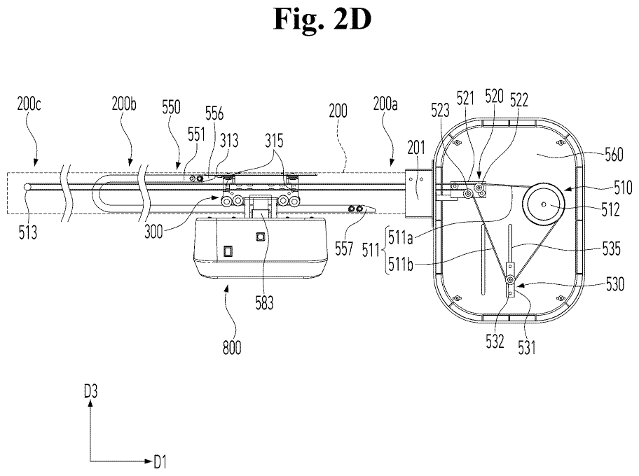

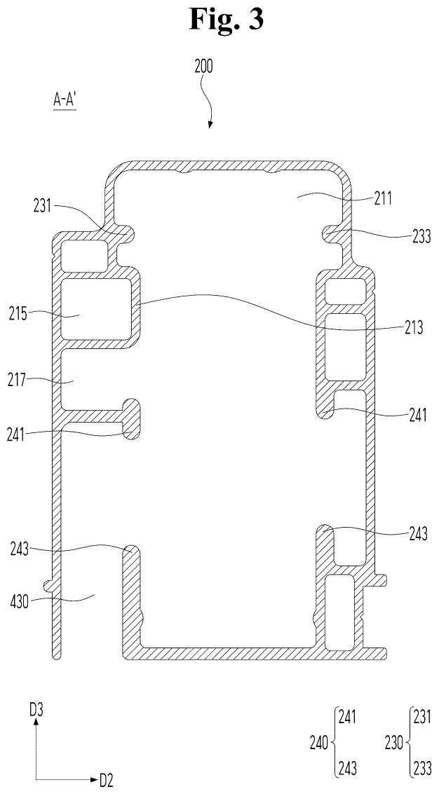

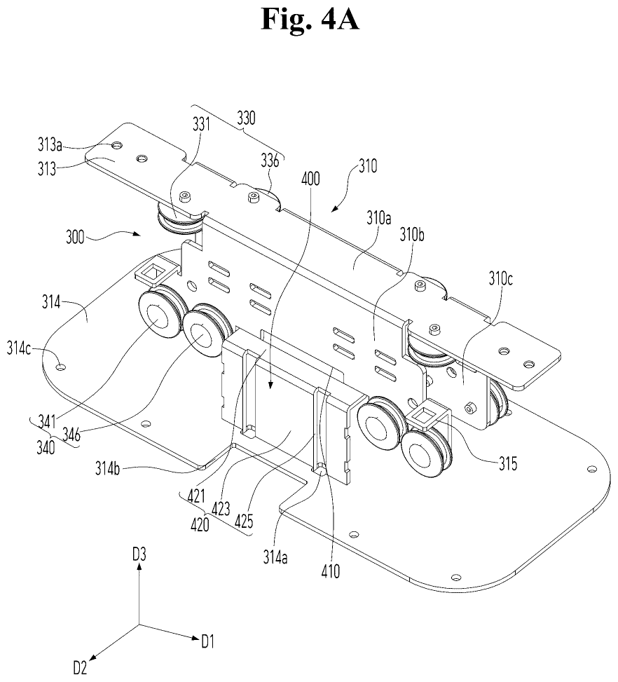

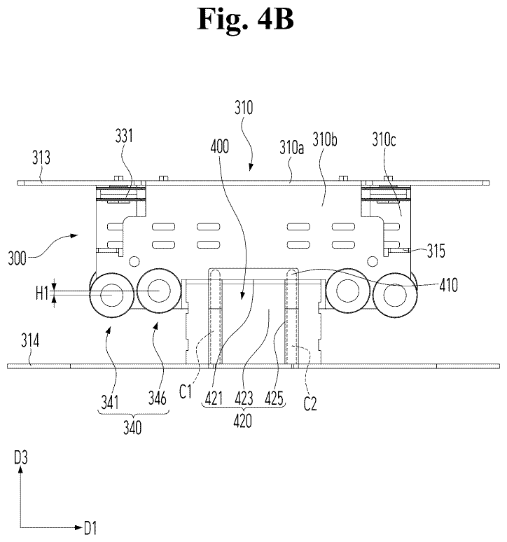

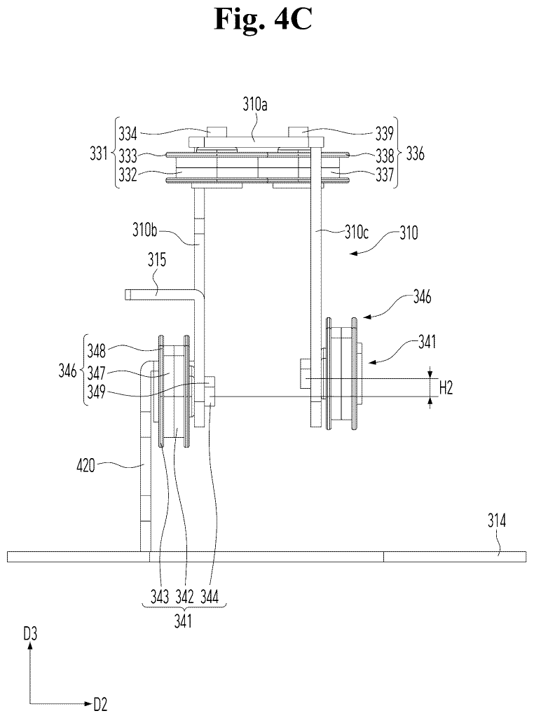

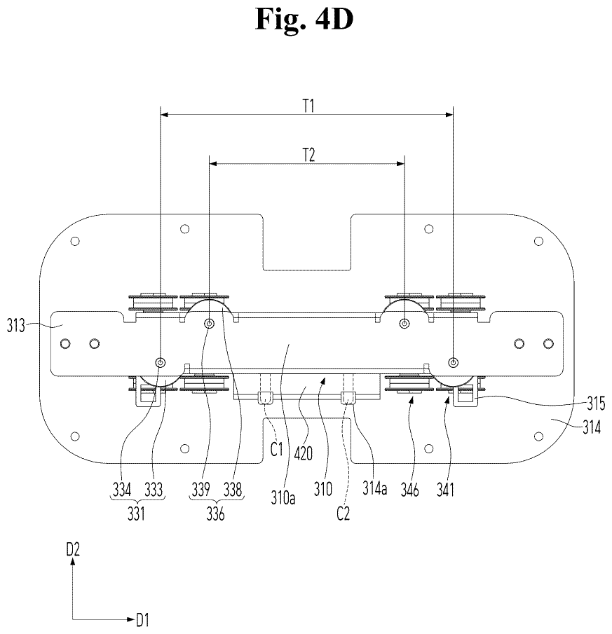

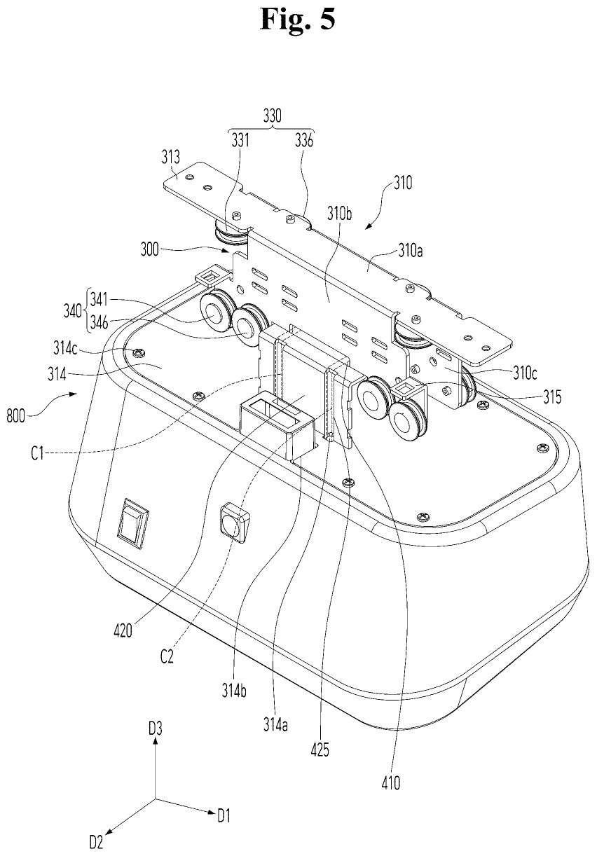

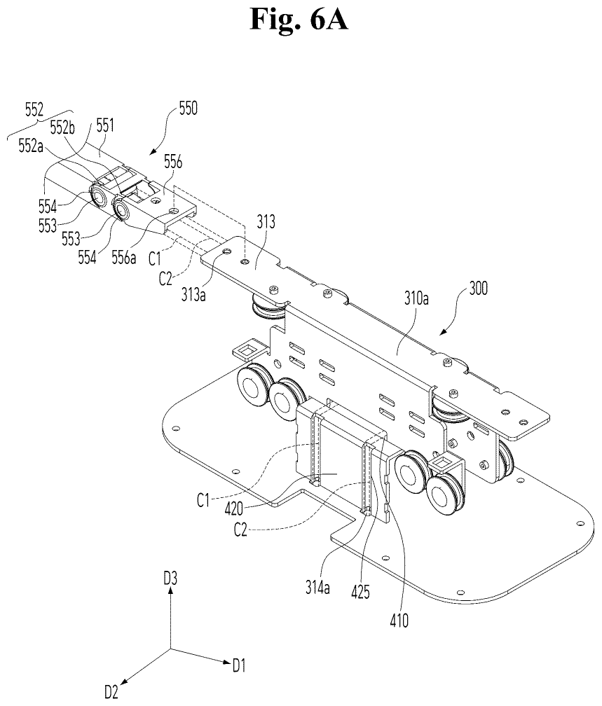

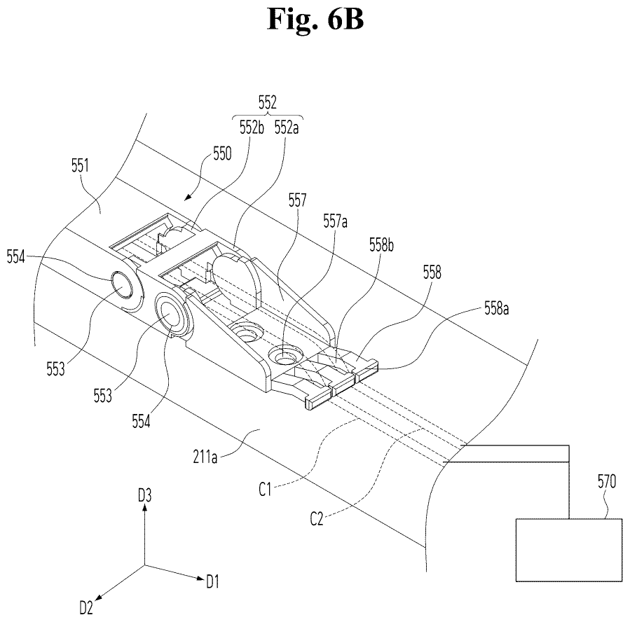

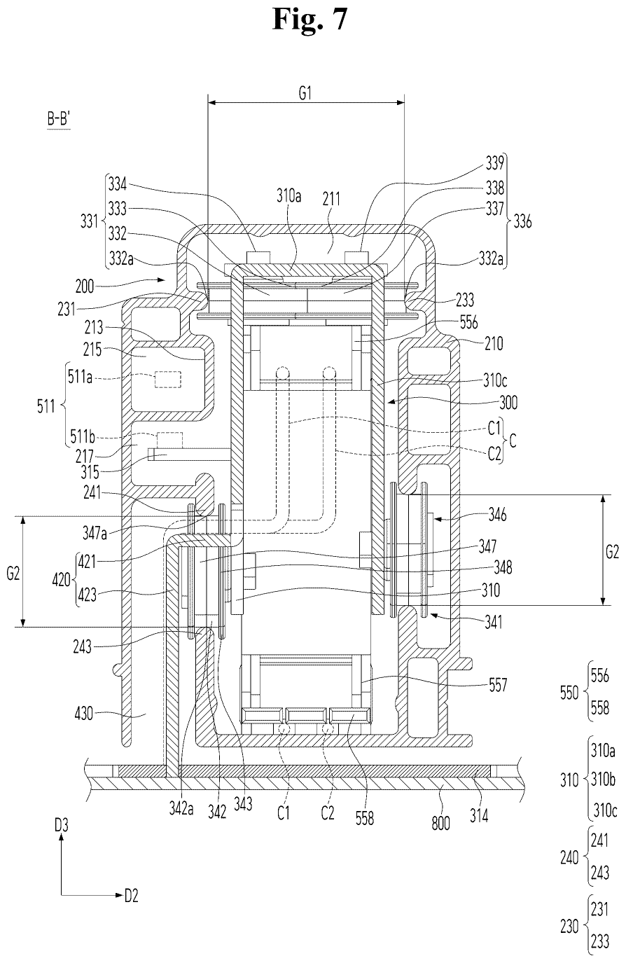

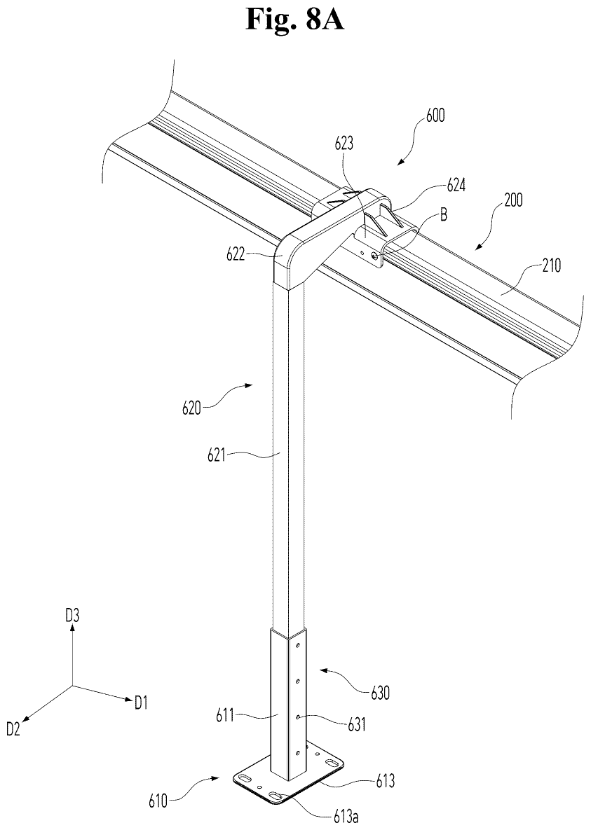

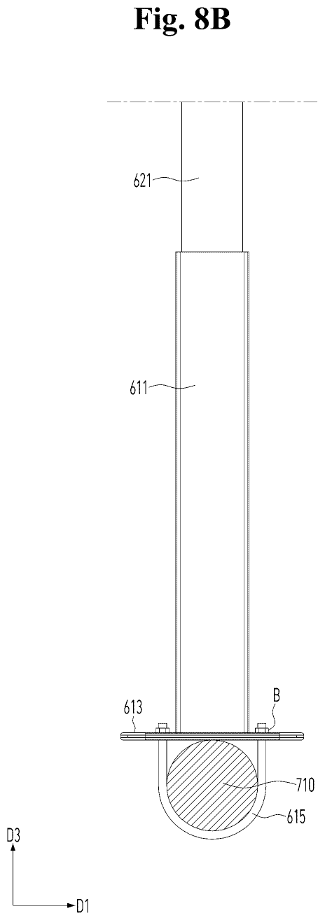

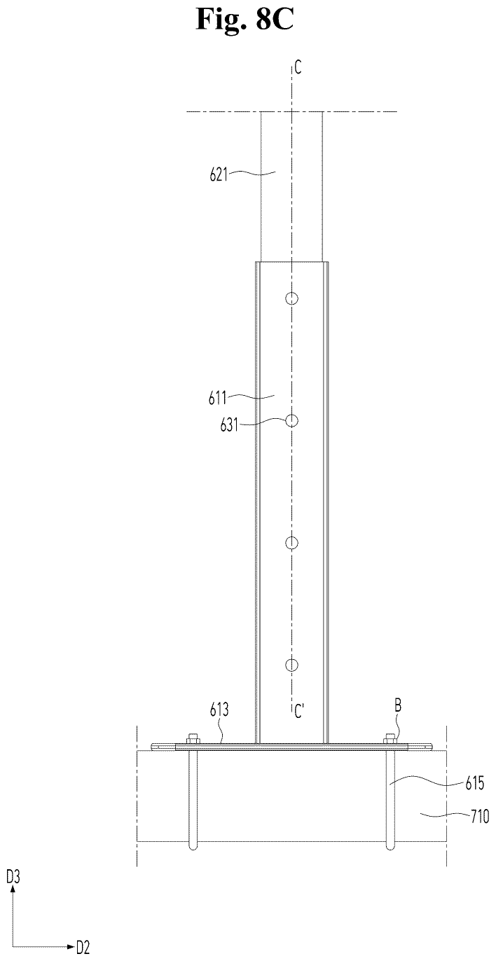

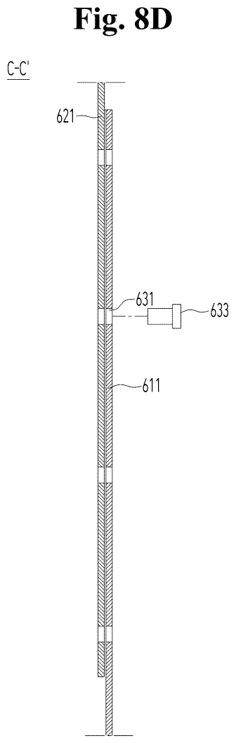

FIG. 1 is a perspective view illustrating a biometric scanning system for livestock 100 according to some embodiments of the present disclosure. FIG. 2A is a front view illustrating a driving unit 500 and a rail member 200 according to some embodiments of the present disclosure. FIG. 2B is a front view illustrating an interior of a control box 560 according to some embodiments of the present disclosure. FIG. 2C is a rear perspective view illustrating an interior of a control box 560 according to some embodiments of the present disclosure. FIG. 2D is a view illustrating a structure of first and second transfer units 510 and 550 disposed inside a rail member 200 and a control box 560 according to some embodiments of the present disclosure. FIG. 3 is a cross-sectional view illustrating the section A-A′ shown in FIG. 2A. FIG. 4A is a perspective view illustrating a moving member 300 according to some embodiments of the present disclosure. FIG. 4B is a front view illustrating a moving member 300 according to some embodiments of the present disclosure. FIG. 4C is a side view illustrating a moving member 300 according to some embodiments of the present disclosure. FIG. 4D is a plan view illustrating a moving member 300 according to some embodiments of the present disclosure. FIG. 5 is a view illustrating a coupled state between a moving member 300 and a scanner 800 according to some embodiments of the present disclosure. FIG. 6A is a view illustrating a coupling structure between a moving member 300 and a first chain coupling portion 556 of a carrier chain according to some embodiments of the present disclosure. FIG. 6B is a view illustrating a coupling structure between a second chain coupling portion 557 of a carrier chain and a bottom surface of a linear room 211 according to some embodiments of the present disclosure. FIG. 7 is a cross-sectional view illustrating the section B-B′ shown in FIG. 2A. FIG. 8A is a perspective view illustrating a height adjustment member 600 according to some embodiments of the present disclosure. FIG. 8B is a front view illustrating a height adjustment member 600 according to some embodiments of the present disclosure. FIG. 8C is a side view illustrating a height adjustment member 600 according to some embodiments of the present disclosure. FIG. 8D is a cross-sectional view illustrating the section C-C′ shown in FIG. 8C.

Referring to FIGS. 1 through 8D, a biometric scanning system for livestock 100 according to an embodiment of the present disclosure may include a moving member 300, a rail member 200, a height adjustment member 600, a driving unit 500, a cable guide unit 400, a scanner 800, and a cage member 700.

The scanner 800 described below may include various sensors such as a color sensor, a depth sensor, a temperature sensor, and a magnetic detection sensor.

In the present disclosure, the color sensor may detect optical signals received from the outside and extract color information from those signals. The color sensor may mainly include an optical sensing element composed of a plurality of pixels. However, the present disclosure is not limited thereto.

Specifically, the color sensor may separate incoming light into specific wavelength bands through a color filter array disposed on each pixel, and generate color information such as RGB (Red, Green, Blue) based on the wavelength information of the light reaching each individual pixel.

In the present disclosure, the depth sensor may refer to a sensor that measures the distance to a target. The depth sensor may operate based on principles such as Time-of-Flight (ToF), structured light, or stereo vision.

For example, the depth sensor may calculate the time it takes for a signal (e.g., infrared light) emitted from a light source to be reflected off a target and return to the depth sensor, or may analyze a distorted pattern created when the emitted signal is reflected on the surface of the target, to calculate the distance to the target. However, the present disclosure is not limited thereto.

In the present disclosure, the temperature sensor may detect infrared radiation emitted from a measurement target to calculate the temperature of livestock (for example, a sow). The temperature sensor may be an infrared sensor or a thermal imaging camera. However, the present disclosure is not limited thereto.

In the present disclosure, the magnetic detection sensor may detect the presence and intensity of a magnetic field by measuring voltage changes induced by the magnetic field. The magnetic field may be generated by at least one magnetic portion disposed on the rail member. The magnetic detection sensor may be a Hall sensor. However, the present disclosure is not limited thereto.

In addition, various sensors may be provided in the scanner 800, enabling the measurement of various types of biometric information related to livestock.

Referring to FIGS. 4A to 5, a scanner 800 configured to measure biometric information of livestock may be mounted on the moving member 300. The moving member 300 may be disposed at the rail member 200 and may move along a longitudinal direction D1 of the rail member 200.

The moving member 300 may include a moving frame 310 and a moving unit.

The moving frame 310 may be disposed inside the rail member 200 and may move along a longitudinal direction D1 of the rail member 200.

The moving frame 310 may include a top plate 310a, a first side plate 310b, a second side plate 310c, a belt link portion 315, a chain link portion 313, and a fixing plate 314.

The top plate 310a may have a flat plate shape and may extend in a longitudinal direction D1. In an embodiment of the present disclosure, the top plate 310a may have a rectangular plate shape extending in the longitudinal direction D1; however, it is not limited thereto and may be implemented in various shapes that do not interfere with an inner surface of a linear room 211 described later.

The first side plate 310b may have a flat plate shape, may be connected to one end of the top plate 310a, and may be disposed in a downward direction.

The second side plate 310c may have a flat plate shape, may be connected to the other end of the top plate 310a, and may be disposed in a downward direction.

The belt link portion 315 may be arranged to protrude in an outward direction from the first side plate 310b. The belt link portion 315 may be arranged in pairs at a front portion and a rear portion along the longitudinal direction D1 of the first side plate 310b. In an embodiment of the present disclosure, the belt link portion 315 may have a rectangular plate shape; however, it is not necessarily limited thereto, and may be implemented in various shapes that do not interfere with an inner surface of the lower belt room 217 to be described later.

Coupling holes may be formed respectively in the pair of belt link portions 315, and ends of the timing belt 511 may be connected to the coupling holes. When the timing belt 511 moves, the moving frame 310 connected by the timing belt 511 and the belt link portions 315 may move along the longitudinal direction D1 of the rail member 200.

The chain link portion 313 may have a flat plate shape and may be disposed at an end of the top plate 310a. A plurality of fastening holes 313a may be arranged in the chain link portion 313. As shown in FIG. 6A, a first chain coupling portion 556 of a carrier chain 551 to be described later may be bolt-coupled to the chain link portion 313.

The fixing plate 314 may have a flat plate shape and may be connected to a lower end of a cable support block 420 to be described later. A plurality of fastening holes 314c may be arranged on the fixing plate 314, and as shown in FIG. 5, a scanner 800 may be bolt-fastened and coupled to a lower portion of the fixing plate 314.

A cutout 314b cut in an inward direction may be formed on the fixing plate 314. A magnetic detection sensor 583 of the scanner 800, which will be described later, may be inserted and disposed in the cutout 314b.

The moving unit may be disposed on an upper portion or a side portion of the moving frame 310 and may guide movement of the moving frame 310 inside the rail member 200.

The moving unit may include a first moving unit 330 and a second moving unit 340.

The first moving unit 330 may be disposed on an upper portion of the moving frame 310 and may guide movement of the moving frame 310. In addition, the first moving unit 330 may support movement of the moving frame 310 along a width direction D2.

The first moving unit 330 may include a first caster unit 331 and a second caster unit 336.

The first caster unit 331 may be disposed on one side of an upper portion of the moving frame 310.

The first caster unit 331 may include a first rotation shaft 334, a first caster body 332, and a first caster flange 333.

The first rotation shaft 334 may be disposed on the top plate 310a of the moving frame 310 with its rotation center oriented in a vertical direction D3.

The first caster body 332 may be rotatably connected to the first rotation shaft 334 and may be a wheel having a cylindrical shape.

The first caster flange 333 may be arranged in a pair respectively on an upper portion and a lower portion of the first caster body 332. The pair of first caster flanges 333 may protrude to upper and lower portions of the first guide line 231 to prevent the first caster body 332 from departing from the first guide line 231 in the vertical direction D3.

The second caster unit 336 may be disposed at a position on the opposite side of an upper portion of the moving frame 310 from the first caster unit 331.

The second caster unit 336 may include a second rotation shaft 339, a second caster body 337, and a second caster flange 338.

The second rotation shaft 339 may be disposed on the top plate 310a of the moving frame 310 with a rotation center in a vertical direction D3.

The second caster body 337 may be rotatably connected to the second rotation shaft 339 and may be a wheel having a cylindrical shape.

The second caster flange 338 may be arranged in a pair respectively on an upper portion and a lower portion of the second caster body 337. The pair of second caster flanges 338 may protrude to upper and lower portions of the second guide line 233 to prevent the second caster body 337 from departing from the second guide line 233 in the vertical direction D3.

Referring to FIG. 4D, the first caster unit 331 may be arranged in a pair with a predetermined interval along the longitudinal direction D1 on one side of the top plate 310a. Specifically, the pair of first caster units 331 may be respectively arranged at a front portion and a rear portion of the top plate 310a based on the longitudinal direction D1. In this case, the pair of first rotation shafts 334 may form a first interval T1.

The second caster unit 336 may be arranged in a pair with a predetermined interval along the longitudinal direction D1 on the other side of the top plate 310a. Specifically, the pair of second caster units 336 may be respectively arranged at a front portion and a rear portion of the top plate 310a based on the longitudinal direction D1. In this case, the pair of second rotation shafts 339 may form a second interval T2.

Here, the first interval T1 may be formed to be larger than the second interval T2.

In an embodiment of the present disclosure, based on the longitudinal direction D1 of the moving frame 310, the pair of second rotation shafts 339 may be disposed between the pair of first rotation shafts 334.

As the first and second caster units 331 and 336 are respectively arranged at a front portion and a rear portion on the top plate 310a based on the longitudinal direction D1, even when the moving frame 310 travels inside the rail member 200 or makes a sudden stop to scan a specific livestock, the occurrence of a fish tail phenomenon in the moving frame 310 can be prevented.

The fish tail phenomenon can be defined as a vibration phenomenon in which a rear portion of the moving frame 310, that is, a portion opposite to the traveling direction, swings from side to side like a fish tail fin when the moving frame 310 travels or makes a sudden stop.

In an embodiment of the present disclosure, by arranging a pair of first and second caster units 331 and 336 at predetermined intervals on the front portion and rear portion of the top plate 310a based on the longitudinal direction D1 of the moving frame 310, vibration occurring at a rear portion of the moving frame 310 can be mitigated or prevented.

Meanwhile, referring to FIG. 7, an outer surface of the first caster body 332 may be defined as a first caster surface 332a, and an outer surface of the second caster body 337 may be defined as a second caster surface 337a.

Here, a gap G1 between the first caster surface 332a and the second caster surface 337a may correspond to a gap G1 between a first guide line 231 and a second guide line 233 to be described later.

Accordingly, the first caster body 332 may come into contact with the first guide line 231, and the second caster body 337 may come into contact with the second guide line 233 and rotate, whereby vibration of the moving frame 310 in a width direction D2 can be prevented or mitigated.

In addition to the fact that the pair of first caster unit 331 and second caster unit 336 arranged along the longitudinal direction D1 of the moving frame 310 mitigates the fish tail phenomenon, vibration in the width direction D2 can be further mitigated, and the occurrence of the fish tail phenomenon can be further suppressed, as the first caster body 332 comes into contact with and moves along the first guide line 231, and the second caster body 337 comes into contact with and moves along the second guide line 233.

In other words, the first moving unit 330 may support the movement of the moving frame 310 along both front and rear sides in the longitudinal direction D1 and along the width direction D2, thereby mitigating or preventing vibration from occurring at a rear portion of the moving frame 310 during movement or stop of the moving frame 310.

This provides an advantageous effect of stabilizing the movement of the moving frame 310 inside the rail member 200.

The second moving unit 340 may be disposed on a side portion of the moving frame 310 and may guide movement of the moving frame 310. In addition, the second moving unit 340 may support movement of the moving frame 310 in a vertical direction D3.

The second moving unit 340 may include a first wheel unit 341 and a second wheel unit 346.

The first wheel unit 341 may be disposed on both side portions of the moving frame 310. Specifically, the first wheel unit 341 may be disposed on the first side plate 310b and the second side plate 310c.

The first wheel unit 341 may include a first shaft 344, a first wheel body 342, and a first wheel flange 343.

The first shaft 344 may be disposed on the first side plate 310b and the second side plate 310c of the moving frame 310 with a rotation center in the width direction D2. That is, the first shaft 344 may be provided as a plurality, and each of the plurality of first shafts 344 may be disposed on the first side plate 310b and the second side plate 310c, respectively.

The first wheel body 342 may be rotatably connected to the first shaft 344 and may be a wheel having a cylindrical shape.

The first wheel flange 343 may be arranged in a pair respectively on both side portions of the first wheel body 342. The pair of first wheel flanges 343 may extend to both sides of the lower rail 243 and may prevent the first wheel body 342 from departing from the lower rail 243 in the width direction D2.

Referring to FIGS. 4B and 4C, the second wheel unit 346 may be disposed on a side portion of the moving frame 310 with a predetermined first height difference H1 from the first wheel unit 341. In other words, a second shaft 349 of the second wheel unit 346 and a first shaft 344 of the first wheel unit 341 may form the first height difference H1.

The second wheel unit 346 may include a second shaft 349, a second wheel body 347, and a second wheel flange 348.

The second shaft 349 may be disposed on each of the first side plate 310b or the second side plate 310c of the moving frame 310 with a rotation center in the width direction D2. That is, the first shaft 344 may be provided as a plurality, and each of the plurality of first shafts 344 may be disposed on the first side plate 310b and the second side plate 310c, respectively.

The second wheel body 347 may be rotatably connected to the second shaft 349 and may be a wheel having a cylindrical shape.

The second wheel flange 348 may be arranged in a pair respectively on both side portions of the second wheel body 347. The pair of second wheel flanges 348 may extend to both sides of the upper rail 241 and may prevent the second wheel body 347 from departing from the upper rail 241 in the width direction D2.

Meanwhile, the first wheel unit 341 may be arranged in a pair at a predetermined interval on a side portion of the moving frame 310. Specifically, the first wheel unit 341 may be arranged in a pair respectively at a front portion and a rear portion on the side portion of the moving frame 310 with a cable support block 420 interposed therebetween.

Also, referring to FIG. 4C, the first wheel unit 341 may be disposed on the first side plate 310b and the second side plate 310c with a predetermined second height difference H2. That is, the first wheel unit 341 disposed on the first side plate 310b and the first wheel unit 341 disposed on the second side plate 310c may have a predetermined second height difference H2.

In addition, the second wheel unit 346 may be arranged in a pair at a predetermined interval on a side portion of the moving frame 310. Similarly, the second wheel unit 346 may be arranged in a pair respectively at a front portion and a rear portion on the side portion of the moving frame 310 with a cable support block 420 interposed therebetween.

Similarly, although not shown in the drawings, the second wheel unit 346 may be disposed on the first side plate 310b and the second side plate 310c with a predetermined second height difference H2, in the same manner as the first wheel unit 341. That is, the second wheel unit 346 disposed on the first side plate 310b and the second wheel unit 346 disposed on the second side plate 310c may have a predetermined second height difference H2.

In an embodiment of the present disclosure, based on the longitudinal direction D1 of the moving frame 310, the pair of second shafts 349 may be disposed between the pair of first shafts 344.

As the pair of first wheel units 341 and the pair of second wheel units 346 are respectively disposed at a front portion and a rear portion on the moving frame 310 based on the longitudinal direction D1, even when the moving frame 310 travels inside the rail member 200 or makes a sudden stop to scan a specific livestock, occurrence of a fish tail phenomenon in the moving frame 310 can be prevented.

In an embodiment of the present disclosure, by disposing a pair of first wheel units 341 and a pair of second wheel units 346 at predetermined intervals on a side portion of the moving frame 310 based on the longitudinal direction D1 of the moving frame 310, vibration occurring at a rear portion of the moving frame 310 can be mitigated.

Meanwhile, referring to FIG. 7, a lower surface of the first wheel body 342 may be defined as a first wheel surface 342a, and an upper surface of the second wheel body 347 may be defined as a second wheel surface 347a.

Here, a gap G2 or height difference between the first wheel surface 342a and the second wheel surface 347a may correspond to a gap G2 between an upper rail 241 and a lower rail 243 to be described later.

Accordingly, as the first wheel body 342 comes into contact with the lower rail 243 and the second wheel body 347 comes into contact with the upper side and rotates, vibration of the moving frame 310 in a vertical direction D3 can be prevented or mitigated.

In addition to the fact that the first wheel unit 341 and the second wheel unit 346 are arranged in a pair along the longitudinal direction D1 of the moving frame 310 to mitigate the fish tail phenomenon, as the first wheel body 342 comes into contact with the lower rail 243 and the second wheel body 347 comes into contact with and moves along the upper rail 241, vibration in the vertical direction D3 can be further mitigated, and the occurrence of the fish tail phenomenon can be further suppressed.

In other words, the second moving unit 340 may support the movement of the moving frame 310 along both front and rear sides in the longitudinal direction D1 and along the vertical direction D3, thereby mitigating or preventing vibration from occurring at a rear portion of the moving frame 310 during movement or stop of the moving frame 310.

This has an advantageous effect of stabilizing the movement of the moving frame 310 inside the rail member 200.

Referring to FIGS. 5, 6A, and 7, the cable guide unit 400 may guide the cable C to be connected toward the scanner 800 from inside the moving frame 310. Specifically, a carrier chain 551 may be disposed inside the moving frame 310. The carrier chain 551 may allow the cable C, which is connected to the controller 570, to move along the longitudinal direction D1 of the rail member 200, and the cable C of the carrier chain 551 may be connected to the scanner 800.

The cable guide unit 400 may be disposed in connection between the rail member 200 and the moving member 300, and may guide the cable C connected to the scanner 800 to move along the longitudinal direction D1 of the rail member 200. The cable guide unit 400 may prevent the cable C from interfering with the rail member 200 while the moving frame 310 is moving.

The cable guide unit 400 may include a cable hole 410, a cable support block 420, an interference prevention hole 425, a plate hole 314a, and a cable outlet room 430.

The cable hole 410 may be formed through the first side plate 310b, which forms a side portion of the moving frame 310. The cable C of the carrier chain 551 may protrude to the outside from the inside of the moving frame 310 through the cable hole 410. In this case, the cable C may be positioned between the upper rail 241 and the lower rail 243 inside the rail member 200.

The cable support block 420 may have a plate shape bent at a right angle, with a vertical portion and a horizontal portion extending perpendicularly from each other, and may be disposed to protrude outward from the first side plate 310b. The cable support block 420 may pass between the upper rail 241 and the lower rail 243 and may be disposed in the cable outlet room 430.

The cable support block 420 may include a first block 421 and a second block 423.

The first block 421 may protrude outward in the width direction D2 from the first side plate 310b, which forms a side portion of the moving frame 310. The first block 421 may be inserted into a space between the upper rail 241 and the lower rail 243. The first block 421 may have a rectangular plate shape, but is not necessarily limited thereto.

The second block 423 may be connected to a lower portion of the first block 421 and may be disposed in a vertical direction D3. The second block 423 may be inserted into the cable outlet room 430. The second block 423 may have a rectangular plate shape, but is not necessarily limited thereto.

In this case, the cable outlet room 430 may penetrate along the longitudinal direction D1 of the rail member 200, and the cable support block 420 may be movable along the longitudinal direction D1 of the cable outlet room 430.

The interference prevention hole 425 may be formed to penetrate the cable support block 420 in a vertical direction D3. The cable C that has passed through the cable hole 410 may be disposed in the interference prevention hole 425.

A plurality of interference prevention holes 425 may be formed on the cable support block 420.

In an embodiment of the present disclosure, the cable C may include a first cable C1 and a second cable C2. The first cable C1 may be a power supply cable for the scanner 800. The second cable C2 may be a cable connected to various sensors of the scanner 800.

As the cable C is disposed in the interference prevention hole 425, even when the cable support block 420 is inserted into the cable outlet room 430, the cable C may not come into contact with the cable outlet room 430. Accordingly, when the cable support block 420 moves along the longitudinal direction of the cable outlet room 430, the cable C may not interfere with an inner surface of the cable outlet room 430.

The above-described cable hole 410 and interference prevention hole 425 may be formed at positions corresponding to each other in a vertical direction D3. Therefore, the cable C discharged from the cable hole 410 may be vertically arranged in the vertical direction D3 and may be inserted into the interference prevention hole 425.

The plate hole 314a may be formed on the fixing plate 314 at a position corresponding in the vertical direction D3 to the interference prevention hole 425. Accordingly, the cable hole 410, the interference prevention hole 425, and the plate hole 314a may be positioned on the same vertical line along the vertical direction D3, so the cable C may be arranged vertically in the vertical direction D3 and may sequentially pass through the cable hole 410, the interference prevention hole 425, and the plate hole 314a to be connected to the scanner 800.

An end of the above-described carrier chain 551 may be bolt-fastened and coupled to the chain link portion 313.

Referring to FIGS. 6A and 7, the cable C of the carrier chain 551 may enter the interior of the moving frame 310 through a lower portion of the chain link portion 313 and be disposed therein. The cable C may be discharged to the outside of the first side plate 310b through the cable hole 410 and, as described above, may be disposed in the interference prevention hole 425 of the cable support block 420.

The cable C discharged downward from the cable outlet room 430 along the interference prevention hole 425 of the cable support block 420 may be inserted into the plate hole 314a formed in the fixing plate 314 and connected to the scanner 800.

Through the above-described cable guide structure, the cable C of the carrier chain 551 may pass through the moving member 300 and the rail member 200, be discharged to the outside, and be stably connected to the scanner 800.

In addition, even during movement of the carrier chain 551 and the moving member 300, the cable C may move together with the cable support block 420 along the longitudinal direction D1 of the cable outlet room 430, providing an advantageous effect of stably maintaining the connection with the scanner 800.

Meanwhile, referring to FIGS. 3 and 7, the rail member 200 may be disposed above the cage member 700.

The rail member 200 may include a rail body 210, a linear room 211, a rail wall portion 213, a cable outlet room 430, an upper belt room 215, a lower belt room 217, and rail guide 230 and 240.

The rail body 210 may form the overall outer shape of the rail member 200 and may have a shape elongated in the longitudinal direction D1. In an embodiment of the present disclosure, the rail body 210 may generally have a rectangular cross-sectional shape, but is not necessarily limited thereto.

The linear room 211 may be formed inside the rail body 210, and the moving member 300 may be disposed in the linear room 211. The linear room 211 may be formed to penetrate the interior of the rail body 210 along the longitudinal direction D1.

The rail wall portion 213 may protrude inward inside the rail body 210. Referring to FIG. 3, the rail wall portion 213 may have a partition wall shape protruding inward toward the linear room 211. Since both side portions of the moving frame 310 have a flat plate shape, the rail wall portion 213 may also have a flat plate shape. The rail wall portion 213 may be disposed along the longitudinal direction D1 inside the rail body 210.

The rail guide 230 and 240 may be disposed inside the rail body 210 and may support movement of the moving member 300 in the width direction D2 or the vertical direction D3.

The rail guide 230 and 240 may include a first rail unit 230 and a second rail unit 240.

The first rail unit 230 may be disposed above the linear room 211 and may support movement of the first caster unit 331 and the second caster unit 336 of the moving member 300.

The first rail unit 230 may include a first guide line 231 and a second guide line 233.

The first guide line 231 may protrude in the width direction D2 from an inner surface of the linear room 211. The first guide line 231 may guide the movement of the first caster unit 331.

As described above, the first caster unit 331 may include a first caster body 332 and a pair of first caster flanges 333.

In this case, the first caster body 332 may be brought into contact with the first guide line 231, and the first guide line 231 may be inserted between the pair of first caster flanges 333, such that the pair of first caster flanges 333 supports upper and lower portions of the first guide line 231. The pair of first caster flanges 333 may prevent the first caster unit 331 from departing from the first guide line 231 and may allow the first caster body 332 to move along the first guide line 231 in the longitudinal direction D1.

The second guide line 233 may protrude toward the first guide line 231 from the opposite inner surface of the linear room 211. The second guide line 233 may guide the movement of the second caster unit 336.

As described above, the second caster unit 336 may include a second caster body 337 and a pair of second caster flanges 338.

Likewise, the second caster body 337 may be brought into contact with the second guide line 233, and the second guide line 233 may be inserted between the pair of second caster flanges 338 such that the pair of second caster flanges 338 supports upper and lower portions of the second guide line 233. The pair of second caster flanges 338 may prevent the second caster unit 336 from departing from the second guide line 233 and may allow the second caster body 337 to move along the second guide line 233 in the longitudinal direction D1.

A gap G1 between the first guide line 231 and the second guide line 233 may correspond to a gap G1 between a first caster surface 332a of the first caster unit 331 and a second caster surface 337a of the second caster unit 336. As described above, the first caster surface 332a may define an outer surface of the first caster body 332, and the second caster surface 337a may define an outer surface of the second caster body 337.

Accordingly, the first caster body 332 may be brought into contact with the first guide line 231, and the second caster body 337 may be brought into contact with and rotated along the second guide line 233, whereby vibration of the moving frame 310 in the width direction D2 can be prevented or mitigated.

The second rail unit 240 may be disposed below the rail wall portion 213 and may support the movement of the first wheel unit 341 and the second wheel unit 346 of the moving member 300.

The second rail unit 240 may include an upper rail 241 and a lower rail 243.

The lower rail 243 may be disposed to protrude upward from a lower end of the rail wall portion 213 toward the upper rail 241. The lower rail 243 may guide the movement of the first wheel unit 341.

As described above, the first wheel unit 341 may include a first wheel body 342 and a pair of first wheel flanges 343.

In this case, the first wheel body 342 may be seated on the lower rail 243, and the lower rail 243 may be inserted between the pair of first wheel flanges 343 such that the first wheel body 342 is disposed on the lower rail 243. The pair of first wheel flanges 343 may prevent the first wheel unit 341 from departing from the lower rail 243 and may allow the first wheel body 342 to move along the lower rail 243 in the longitudinal direction D1.

The upper rail 241 may be disposed to protrude downward from an upper end of the rail wall portion 213. The upper rail 241 may guide the movement of the second wheel unit 346.

As described above, the second wheel unit 346 may include a second wheel body 347 and a pair of second wheel flanges 348.

In this case, the second wheel body 347 may be brought into contact with the upper rail 241. The upper rail 241 may be inserted between the pair of second wheel flanges 348 such that the second wheel body 347 is disposed below the upper rail 241.

Even if the second wheel body 347 is not in contact with the upper rail 241, the pair of first wheel flanges 343 may be positioned at locations overlapping both side portions of the upper rail 241 in the vertical direction D3. Accordingly, the second wheel unit 346 may not depart from the upper rail 241 and may be allowed to move along the upper rail 241 in the longitudinal direction D1.

Meanwhile, based on the vertical direction D3, the first shaft 344 of the first wheel unit 341 and the second shaft 349 of the second wheel unit 346 may be disposed at different positions. As described above, on the moving frame 310, the second shaft 349 may be disposed at a relatively higher position than the first shaft 344.

A gap G2 between the upper rail 241 and the lower rail 243 may correspond to a vertical gap between a first wheel surface 342a of the first wheel unit 341 and a second wheel surface 347a of the second wheel unit 346. The gap G2 may be equal to the height between the first wheel surface 342a of the first wheel unit 341 and the second wheel surface 347a of the second wheel unit 346.

As described above, the first wheel surface 342a may define a lower surface of the first wheel body 342, and the second wheel surface 347a may define an upper surface of the second wheel body 347.

Accordingly, as the first wheel body 342 comes into contact with the lower rail 243 and the second wheel body 347 comes into contact with and rotates along the upper rail 241, vibration of the moving frame 310 in the vertical direction D3 can be prevented or mitigated.

The upper belt room 215 may be formed to penetrate the rail wall portion 213 and may accommodate an upper timing belt 511a of the timing belt 511 configured in the form of caterpillar tracks. In an embodiment of the present disclosure, the upper belt room 215 may generally have a shape with a rectangular cross-section, but is not necessarily limited thereto, and other shapes that do not come into contact with the upper timing belt 511a are also possible.

The lower belt room 217 may be formed recessed in a width direction D2 into the rail wall portion 213. A lower timing belt 511b of the timing belt 511 configured in the form of caterpillar tracks may be disposed in the lower belt room 217. In an embodiment of the present disclosure, the lower belt room 217 may generally have a shape with a rectangular cross-section, but is not necessarily limited thereto, and other shapes that do not come into contact with the lower timing belt 511b are also possible.

A belt link portion 315 coupled to the lower timing belt 511b may be disposed in the lower belt room 217 together with the lower timing belt 511b.

When a motor 514 of a driving unit 500, to be described later, rotates, the upper timing belt 511a may move along the longitudinal direction D1 of the upper belt room 215, and the lower timing belt 511b may move along the longitudinal direction D1 of the lower belt room 217. Here, the upper timing belt 511a and the lower timing belt 511b may move in opposite directions.

The cable outlet room 430 may be formed to penetrate a lower portion of the rail body 210 along the longitudinal direction D1. The cable C in the moving member 300 may be discharged to the outside through the cable outlet room 430 and may be connected to the scanner 800.

The cable outlet room 430 may be in communication with a space between the upper rail 241 and the lower rail 243.

Therefore, the cable C may pass between the upper rail 241 and the lower rail 243 and be discharged to the outside through the cable outlet room 430.

The rail member 200 according to an embodiment of the present disclosure may stably guide the movement of the moving member 300 through the above-described structure. In addition, by separating the movement space of the timing belt 511 and the moving member 300, the movement of the timing belt 511 and the moving member 300 can be made smooth, and interference between them can be prevented.

Meanwhile, referring to FIGS. 2A to 2D, the driving unit 500 may move the cable C that connects the moving member 300 or the scanner 800 to the controller 570 along the rail member 200.

The driving unit 500 may include a control box 560, a first transfer unit 510, and a second transfer unit 550.

The control box 560 may be fixed to the cage member 700 by a support bracket 563. The control box 560 may be connected to an end of the rail member 200 by a rail bracket 201, and a box hole 561 in communication with the interior of the rail member 200 may be formed. A controller 570 may be housed inside the control box 560. The controller 570 may control power supplied to the scanner 800 and collect biometric data of livestock from various sensors installed in the scanner 800.

The first transfer unit 510 may be disposed inside the control box 560 and inside the rail member 200, and may move the moving member 300 along the longitudinal direction D1 of the rail member 200.

The first transfer unit 510 may include a motor 514, a first driving pulley 512, a second driving pulley 513, a timing belt 511, a position adjustment unit 520, and a tension adjustment unit 530.

The motor 514 may transmit rotational force to the timing belt 511 and may be disposed inside the control box 560.

The first driving pulley 512 may be disposed inside the control box 560 and may be connected to a drive shaft of the motor 514. A plurality of gear teeth may be formed along the circumferential direction on the outer circumferential surface of the first driving pulley 512.

The second driving pulley 513 may be disposed at the opposite side 200c of the rail member 200, which is positioned opposite to the control box 560, inside the rail member 200. A plurality of gear teeth may also be formed along the circumferential direction on the outer circumferential surface of the second driving pulley 513.

Specifically, the control box 560 may be connected to one side portion 200a of the rail member 200. Accordingly, the first driving pulley 512 may be disposed adjacent to the one side portion 200a of the rail member 200. The second driving pulley 513 may be disposed inside the linear room 211 at the other side portion 200c of the rail member 200.

That is, the first driving pulley 512 and the second driving pulley 513 may be disposed on opposite ends of the rail member 200 along the longitudinal direction D1.

The timing belt 511 may be connected in the form of caterpillar tracks between the first driving pulley 512 and the second driving pulley 513. Although not shown in the drawings, a plurality of gear teeth may also be formed on the surface of the timing belt 511. The gear teeth of the timing belt 511 may engage with the gear teeth of the first driving pulley 512 and the second driving pulley 513.

Accordingly, when the motor 514 is driven, the first driving pulley 512 may rotate, and the timing belt 511 may rotate in the form of caterpillar tracks, thereby moving the moving member 300 along the longitudinal direction D1 of the rail member 200. In this case, the second driving pulley 513 may support the rotation of the timing belt 511.

As described above, since the timing belt 511 may be coupled to the belt link portion 315 of the moving member 300, when the timing belt 511 rotates in the form of caterpillar tracks, the moving member 300 may move together with the timing belt 511 along the linear room 211 of the rail member 200.

Meanwhile, referring to FIG. 7, as described above, a lower belt room 217 and an upper belt room 215 may be formed on a side portion of the rail wall portion 213 inside the rail member 200.

An upper timing belt 511a of the timing belt 511 configured in the form of caterpillar tracks may be disposed in the upper belt room 215, and may respectively engage with the first driving pulley 512 and the second driving pulley 513 through the upper belt room 215. When the motor 514 rotates, the upper timing belt 511a may move along the longitudinal direction D1 inside the upper belt room 215.

A lower timing belt 511b of the timing belt 511 configured in the form of caterpillar tracks may be disposed in the lower belt room 217, and may respectively engage with the first driving pulley 512 and the second driving pulley 513 through the lower belt room 217. When the motor 514 rotates, the lower timing belt 511b may move along the longitudinal direction D1 inside the lower belt room 217.

As described above, the lower timing belt 511b may be connected to the belt link portion 315, and the belt link portion 315 may move along the longitudinal direction D1 through the lower belt room 217.

Referring to FIG. 2b to FIG. 2d, the position adjustment unit 520 may be disposed inside the control box 560 and may adjust the vertical position of the timing belt 511.

The position adjustment unit 520 may include a position adjustment hole 525, a position adjustment block 521, a position adjustment fastener 524, a first adjustment pulley 522, and a second adjustment pulley 523.

The position adjustment hole 525 may be formed through the control box 560 in the vertical direction (D3).

The position adjustment block 521 may be placed in the position adjustment hole 525. The position adjustment block 521 may be in the shape of a rectangular block, but it is not limited to this shape.

The position adjustment fastener 524 may adjust the vertical position of the position adjustment block 521 in the position adjustment hole 525. The position adjustment fastener 524 may include a fixed bolt 524a, fixed nut 524b, and fixed washer 524c.

The fixed bolt 524a may pass through the position adjustment block 521 and be inserted into the position adjustment hole 525.

On the opposite side of the position adjustment hole 525 relative to the fixed bolt 524a, the fixed nut 524b and fixed washer 524c may be arranged. First, the fixed washer 524c may be inserted into the fixed bolt 524a and may come into contact with the surface of the position adjustment hole 525. Then, the fixed nut 524b may be screwed onto the fixed bolt 524a, causing the fixed washer 524c to press against the perimeter of the position adjustment hole 525.

By pressing the surfaces of the position adjustment block 521 and the position adjustment hole 525 with the fastening bolt 524a and the fixing washer 524c, the vertical position of the position adjustment block 521 on the position adjustment hole 525 can be fixed.

If it is desired to change the vertical position of the position adjustment block 521, loosen the fixed bolt 524a and the fixed nut 524b in a threaded manner, adjust the vertical position of the position adjustment block 521, and then thread the fixed bolt 524a and the fixed nut 524b back together.

The first adjustment pulley 522 can be placed on the position adjustment block 521. The first adjustment pulley 522 can support the lower part of the upper timing belt 511a.

The second adjustment pulley 523 can be placed on the position adjustment block 521 below the first adjustment pulley 522. The second adjustment pulley 523 can support the lower part of the lower timing belt 511b.

The second adjustment pulley 523 can guide the lower timing belt 511b to move in the direction of the tension adjustment unit 530.

As the vertical position of the position adjustment block 521 is adjusted, the vertical positions of the first adjustment pulley 522 and the second adjustment pulley 523 may change.

When the vertical positions of the first adjustment pulley 522 and the second adjustment pulley 523 are changed, the vertical position of the timing belt 511 may change.

As described above, the upper timing belt 511a may be inserted into the upper belt room 215, and the lower timing belt 511b may be inserted into the lower belt room 217.

Therefore, by adjusting the vertical positions of the first adjustment pulley 522 and the second adjustment pulley 523, it is possible to prevent the upper timing belt 511a from coming into contact with the inner surface of the upper belt room 215. Through this, when the upper timing belt 511a moves, it does not come into contact with the inner surface of the upper belt room 215, thereby preventing interference with the movement of the upper timing belt 511a.

Likewise, it is possible to prevent the lower timing belt 511b from coming into contact with the inner surface of the lower belt room 217. Through this, when the lower timing belt 511b moves, it does not come into contact with the inner surface of the lower belt room 217, thereby preventing interference with the movement of the lower timing belt 511b.

Referring to FIG. 2B to FIG. 2D, the tension adjustment unit 530 can be disposed inside the control box 560, and can adjust the tension of the timing belt 511.

The tension adjustment unit 530 may include a tension adjustment block 531, a tension adjustment pulley 532, a tension adjustment fastener 534, and a tension adjustment hole 535.

The tension adjustment hole 535 may be formed penetrating vertically through the control box 560.

The tension adjustment block 531 may be a rectangular parallelepiped-shaped block, and may be disposed in the tension adjustment hole 535. The tension adjustment fastener 534 can adjust the vertical position of the tension adjustment block 531 on the tension adjustment hole 535. The tension adjustment fastener 534 may include an adjustment bolt 534a, an adjustment nut 534b, and an adjustment washer 534c. The adjustment bolt 534a may pass through the tension adjustment block 531 and be inserted into the tension adjustment hole 535.

Relative to the tension adjustment hole 535, on the opposite side of the adjustment bolt 534a, the adjustment nut 534b and the adjustment washer 534c may be disposed. First, the adjustment washer 534c may be inserted into the adjustment bolt 534a and may come into contact with the surface of the tension adjustment hole 535. Then, the adjustment nut 534b may be threaded onto the adjustment bolt 534a so that the adjustment washer 534c presses the periphery of the tension adjustment hole 535.

By the adjustment bolt 534a and the adjustment washer 534c respectively pressing the surfaces of the tension adjustment block 531 and the tension adjustment hole 535, the vertical position of the tension adjustment block 531 on the tension adjustment hole 535 can be fixed.

If it is desired to change the vertical position of the tension adjustment block 531, the adjustment bolt 534a and the adjustment nut 534b may be loosened in a threaded manner, the vertical position of the tension adjustment block 531 may be adjusted, and then the adjustment bolt 534a and the adjustment nut 534b may be threaded again.

The tension adjustment pulley 532 may be disposed on the tension adjustment block 531 and may apply tension to the lower timing belt 511b.

When the vertical position of the tension adjustment block 531 is adjusted along the tension adjustment hole 535, the tension value applied to the lower timing belt 511b by the tension adjustment pulley 532 may be adjusted.

For example, when the tension value of the timing belt 511 is low and the timing belt 511 sags downward, the first and second driving pulleys 512 and 513 may not properly transmit rotational force to the timing belt 511. In addition, the timing belt 511 may come into contact with the inner surfaces of the upper belt room 215 and the lower belt room 217. That is, interference may occur with the movement of the timing belt 511 inside the upper belt room 215 and the lower belt room 217.

In this case, the adjustment nut 534b may be loosened to release the pressing by the adjustment washer 534c and the tension adjustment block 531 on the periphery of the tension adjustment hole 535.

Thereafter, the tension adjustment block 531 may be adjusted downward along the tension adjustment hole 535.

Since the tension adjustment pulley 532 pushes the lower timing belt 511b further downward, the overall tension of the timing belt 511 may increase.

After the vertical position of the tension adjustment block 531 is adjusted, the adjustment bolt 534a and the adjustment nut 534b may be tightened again so that the vertical position of the tension adjustment block 531 can be fixed.

Conversely, when the tension of the timing belt 511 is too high, the timing belt 511 may be excessively tightly engaged with the first and second driving pulleys 512 and 513. In this case, excessive contact resistance between the first and second driving pulleys 512 and 513 and the timing belt 511 may hinder smooth rotation of the pulleys, thereby causing the movement of the timing belt 511 to become unstable.

In this case, the adjustment nut 534b may be loosened to release the pressing force applied by the adjustment washer 534c and the tension adjustment block 531 on the periphery of the tension adjustment hole 535.

Thereafter, the tension adjustment block 531 may be adjusted upward within the tension adjustment hole 535 by the user.

In this case, as the vertical position of the tension adjustment pulley 532 is adjusted upward, the force applied by the tension adjustment pulley 532 to the lower timing belt 511b becomes weaker, and the overall tension of the timing belt 511 may be reduced.

After adjusting the vertical position of the tension adjustment block 531, the adjustment bolt 534a and the adjustment nut 534b may be tightened again to fix the vertical position of the tension adjustment block 531 in place.

As described above, the first transfer unit 510 may apply the motor 514, the first driving pulley 512, and the second driving pulley 513 to smoothly move the timing belt 511 along the longitudinal direction D1 of the rail member 200.

In addition, by applying the position adjustment unit 520 to prevent the timing belt 511 from coming into contact with the inner surfaces of the upper belt room 215 and the lower belt room 217, the timing belt 511 can be allowed to move smoothly.

Furthermore, by applying the tension adjustment unit 530 to adjust the tension value of the timing belt 511, the rotational force of the motor 514 can be stably transmitted to the timing belt 511.

Referring to FIG. 2D, FIG. 6A, FIG. 6B, and FIG. 7, the second transfer unit 550 may be disposed inside the rail member 200 and may be connected to the moving member 300, and may move the cable C, which is connected between the controller 570 and the scanner 800, along the longitudinal direction D1 of the rail member 200.

The second transfer unit 550 may include a carrier chain 551.

The carrier chain 551 may be disposed inside the rail member 200. Specifically, the carrier chain 551 may be disposed on the inner side of the moving frame 310 and may move along the longitudinal direction D1 of the linear room 211.

Referring to FIG. 6A, the carrier chain 551 may be in a form in which a plurality of chain bodies 552 are connected to one another. The plurality of chain bodies 552 may include a first chain piece 552a and a second chain piece 552b.

Both ends of the first chain piece 552a may be formed in a shape protruding in one direction, and a pair of link holes 554 may be formed on the protruding portions. Both ends of the second chain piece 552b may protrude in the direction opposite to the first chain piece 552a, and a pair of link protrusions 553 may be formed on the protruding portions.

The first chain piece 552a may be formed slightly larger in the width direction D2 than the second chain piece 552b.

The link protrusion 553 formed on one chain body 552 may be coupled to the link hole 554 formed on an adjacent chain body 552, so that the plurality of chain bodies 552 may be connected to each other.

Referring to FIG. 6A, one end of the carrier chain 551 may be coupled to the chain link portion 313 of the moving member 300. A first chain coupling portion 556 may be disposed at one end of the carrier chain 551.

The first chain coupling portion 556 may include a link hole 554 into which a link protrusion 553 of the chain body 552 is inserted, and one or more first chain coupling holes 556a may be formed. One or more chain fastening holes 313a may be formed on the chain link portion 313 of the moving frame 310, and each first chain coupling hole 556a and chain fastening hole 313a may be bolt-fastened to connect the first chain coupling portion 556 and the moving frame 310.

Referring to FIG. 6B, the other end of the carrier chain 551 may be coupled to the bottom surface 211a of the linear room 211. A second chain coupling portion 557 may be disposed at the other end of the carrier chain 551.

The second chain coupling portion 557 may include a link protrusion 553 inserted into a link hole 554 of the chain body 552. One or more second chain coupling holes 557a may be formed.

The second chain coupling hole 557a and the bottom surface 211a of the linear room 211 may be bolt-fastened together.

Meanwhile, the carrier chain 551 may further include a cable fixing beam 558, a cable fixing hole 558b, and a cable fixing protrusion 558a.

The cable fixing beam 558 may be connected to the end of the second chain coupling portion 557 and may be extended along the longitudinal direction D1, and a plurality may be arranged at predetermined intervals along the width direction D2 from the end of the second chain coupling portion 557.

The cable fixing hole 558b may be formed between the plurality of cable fixing beams 558.

The cable fixing protrusion 558a may be a block shape protruding in the width direction D2 from the end of the cable fixing beam 558. In the present embodiment, the cable fixing protrusion 558a may have a rectangular parallelepiped shape, but is not limited thereto.

The cable C disposed inside the carrier chain 551 may pass through the cable fixing hole 558b and change position from top to bottom. At this time, the cable fixing protrusion 558a presses the upper side of the cable C, so that the cable C may be brought into close contact with the bottom surface of the linear room 211 when passing through the cable fixing hole 558b.

Accordingly, when the moving frame 310 moves inside the rail member 200, the cable C may not collide with it, and the cable C may be arranged along the bottom surface 211a of the linear room 211 and connected to the controller 570.

Meanwhile, the cable C may be disposed inside the carrier chain 551. The cable C may connect the controller 570 and the scanner 800. The cable C may include a first cable C1 for supplying power to the scanner 800 and a second cable C2 connected to the sensors of the scanner 800.

The first cable C1 and the second cable C2 may pass through the second chain coupling portion and be arranged along the bottom surface 211a of the linear room 211, and may be connected to the controller 570 through the control box 560.

In addition, the first cable C1 and the second cable C2 may pass through the first chain coupling portion and be disposed inside the moving frame 310. As described above, the cable C may protrude to the side of the moving frame 310 through the cable hole 410. The cable C may be inserted into the interference prevention hole 425 of the cable support block 420 and may be arranged in the direction of the scanner 800 through the cable outlet room 430. Further, the cable C may be connected to the scanner 800 through the plate hole 314a formed in the fixing plate 314.

When the moving member 300 is positioned at one end portion 200a of the rail member, the bent portion of the carrier chain 551 from top to bottom may be located at the middle portion 200b of the rail member 200. Accordingly, when the moving member 300 moves from the one end portion 200a of the rail member 200 to the other end portion 200c, the bent portion of the carrier chain 551 may move from the middle portion 200b to the other end portion 200c. That is, the plurality of chain bodies 552 connected to each other may continuously bend and move from the middle portion 200b to the other end portion 200c of the rail member 200.

As described above, the second transfer unit 550 may stably move the cable C along the longitudinal direction D1 of the rail member 200 through the carrier chain structure, and may be connected to the scanner 800 through the first chain coupling portion 556 and the cable guide unit 400 while passing through the moving member 300. In addition, through the cable fixing hole 558b, the cable fixing beam 558, and the cable fixing protrusion 558a, it is possible to connect the cable C to the controller 570 via the bottom surface 211a of the linear room 211 without interfering with the moving member 300.

Meanwhile, referring to FIG. 2A, the driving unit 500 may further include a position detection unit 580. The position detection unit 580 may be disposed on the rail member 200 and the scanner 800, and may measure the position of the scanner 800 on the rail member 200.

The position detection unit 580 may include a magnetic portion 581 and a magnetic detection sensor 583.

The magnetic portion 581 may be arranged in plurality at predetermined intervals along the longitudinal direction of the rail member 200. In the present embodiment, the magnetic portion 581 may be a permanent magnet, but is not limited thereto.

The magnetic detection sensor 583 may be disposed on the upper side of the scanner 800 and may detect the magnetic portion 581.

When the scanner 800 moves along the longitudinal direction of the rail member 200, the magnetic detection sensor 583 detects the magnetic portion 581, and the controller 570 may recognize the current position of the scanner 800 on the rail member 200.

Meanwhile, referring to FIG. 1 and FIGS. 8A to 8D, the height adjustment member 600 may be disposed between the cage member 700 and the rail member 200, and may adjust the height between the cage member 700 and the rail member 200.

The cage member 700 may be installed in a livestock farm where animals are raised. The floor of the livestock farm is mostly soil and may be uneven and bumpy.

The cage member 700 may include a plurality of cage frames 710. Each of the plurality of cage frames 710 may accommodate and raise livestock. Since the floor of the livestock farm is uneven, specific cage frames 710 may be arranged at different heights from the other cage frames 710.

On the rail member 200, the scanner 800 may move along the longitudinal direction D1 by the moving member 300. The scanner 800 may move along the longitudinal direction D1 of the rail member 200 and measure biometric information of livestock housed in each of the plurality of cage frames 710.

Therefore, the rail member 200 must be horizontally arranged above the plurality of cage frames 710 regardless of the condition of the livestock farm floor.

The height adjustment member 600 may be disposed between the upper ends of the cage frames 710 and the rail member 200, and may allow the rail member 200 to be arranged relatively horizontally.

The height adjustment member 600 may include a first pole unit 610, a second pole unit 620, and a height adjustment unit 630.

The first pole unit 610 may be disposed on the upper side of the cage member 700.

The first pole unit 610 may include a first pole body 611 and a first pole bracket 613.

The first pole body 611 may be a beam having a rectangular cross-section, and the interior of the first pole unit 610 may be penetrated in the vertical direction D3.

The first pole bracket 613 may be disposed at the lower portion of the first pole body 611 and may be fixed to the upper side of the cage member 700. The first pole bracket 613 may have a plate shape, and a plurality of bolt holes 613a may be formed. The first pole unit 610 may be fixed to the upper side of the cage member 700 by fastening the cage bracket 615 and the bolt holes 613a with a nut B, with the cage frame 710 interposed therebetween.

In the embodiment of the present disclosure, the cage bracket 615 may have a U-shape, and threads may be formed at the nut B fastening portion. However, the cage bracket 615 may also be applied in other bracket shapes.

The second pole unit 620 may be connected to the upper side of the first pole unit 610 so as to be vertically movable, and may support the rail member 200.

The second pole unit 620 may include a second pole body 621, a support beam 622, and a second pole bracket 623.

The second pole body 621 may be inserted into the upper side of the first pole body 611, and may be vertically movable in the vertical direction D3. The second pole body 621 may be a beam having a rectangular cross-section slightly smaller than that of the first pole body 611.

The support beam 622 may be disposed at the upper portion of the second pole body 621 and may be a bent beam shape oriented toward the rail member 200.

The second pole bracket 623 may be disposed at the end of the support beam 622 and may be coupled to the upper side of the rail member 200. Since the scanner 800 moves beneath the rail member 200, the second pole bracket 623 may be coupled to the upper side of the rail member 200 so as not to interfere with the movement of the scanner 800. In this case, the second pole bracket 623 and the upper side of the rail member 200 may be fastened together using a bolt B.

At this time, a reinforcement beam 624 may be disposed between the support beam 622 and the second pole bracket 623. The reinforcement beam 624 may enhance the connection between the support beam 622 and the second pole bracket 623, and may allow the second pole bracket 623 to support the rail member 200 more stably.

The height adjustment unit 630 may be disposed on the first pole unit 610 and the second pole unit 620, and may adjust the height between the cage member 700 and the rail member 200.

The height adjustment unit 630 may include a first height adjustment hole 631, a second height adjustment hole 632, and a height adjustment fastener 633.

The first height adjustment hole 631 may be formed penetrating through the first pole body 611, and a plurality of them may be arranged at predetermined intervals in the vertical direction along the first pole body 611.

The second height adjustment hole 632 may be formed penetrating through the second pole body 621, and a plurality of them may be arranged at predetermined intervals in the vertical direction along the second pole body 621.

Here, the intervals between the plurality of first height adjustment holes 631 and the plurality of second height adjustment holes 632 may be the same.

The height adjustment fastener 633 may be engaged with the first height adjustment hole 631 and the second height adjustment hole 632 and may fix the vertical position between the first pole body 611 and the second pole body 621.

The plurality of cage frames 710 may be arranged at predetermined intervals along the longitudinal direction D1 of the rail member 200.

In this case, the height adjustment member 600 may be disposed on one or more of the plurality of cage frames 710.

If the ground of the livestock farm is uneven and certain cage frames 710 are positioned at different heights compared to other cage frames 710, the height adjustment fastener 633 may be removed from the first and second height adjustment holes 631 and 632, and the vertical position of the second pole body 621 may be adjusted on the first pole body 611.

Then, the height adjustment fastener 633 may be inserted into the first and second height adjustment holes 631 and 632 to fix the vertical position between the first pole body 611 and the second pole body 621.

That is, by adjusting the height between the first pole unit 610 and the second pole unit 620 in accordance with the height of each cage frame 710, the rail member 200 can be arranged relatively horizontally. The scanner 800 can move relatively horizontally along the longitudinal direction D1 of the rail member 200, and can stably sense the biometric information of livestock housed in the plurality of cage frames 710.

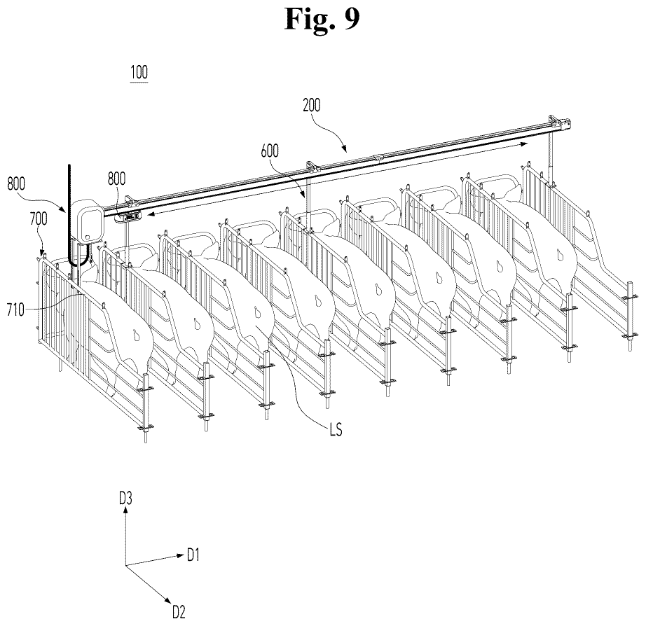

Referring to FIG. 9, it can be confirmed that livestock LS are arranged between the plurality of cage frames 710.

When the operator operates the controller 570, the biometric scanning system for livestock 100 is activated, and may scan the biometric information of the livestock periodically or non-periodically.

That is, as described above, the motor 514 rotates, and the timing belt 511 moves, thereby moving the moving member 300 along the longitudinal direction D1 of the rail member 200. Accordingly, the scanner 800 can move in the direction of the arrow and scan the biometric information of each livestock LS.

Since a plurality of magnetic portions 581 are arranged on the rail member 200 at predetermined intervals, the current position of the scanner 800 can be identified through the magnetic detection sensor 583.

At this time, the cable C connecting the controller 570 and the scanner 800 can move stably inside the rail member 200 by means of the carrier chain 551.

In addition, by means of the height adjustment unit 630, the gap between the rail member 200 and the cage frame 710 can be adjusted according to the height of each cage frame 710, so that the rail member 200 can be arranged relatively horizontally. Accordingly, the scanner 800 can move relatively horizontally and stably along the rail member 200, and measure the biometric information of the livestock LS.

According to the above-described structure, the present disclosure can quickly and accurately collect biometric information such as the body condition score, body temperature, body weight, and back fat thickness of a plurality of livestock. Through this, it is possible to monitor the real-time status of the plurality of livestock, so that in situations such as when specific livestock become ill, treatment, prevention, and other actions can be taken promptly. In addition, it is possible to easily determine whether specific livestock have reached breeding targets. This can assist in establishing additional breeding plans, shipment plans, and the like. Furthermore, the smart system can be implemented on a farm with a relatively simple structure. This makes it possible to avoid complicating the farm layout, increase the appropriateness of construction costs, and facilitate maintenance. Moreover, because biometric information of livestock can be acquired in a non-contact manner, stress on the animals can be minimized.

Meanwhile, although the present disclosure has been described with reference to the accompanying drawings, such descriptions are merely exemplary and are not limited to specific embodiments. Various modifications can be made by those skilled in the art to which the present invention pertains, and such modifications are also within the scope of rights defined by the claims. Also, such modified embodiments should not be understood separately from the technical idea of the present invention.

What is claimed is:

1. A biometric scanning system for livestock, comprising:
a cage member configured to accommodate livestock;
a rail member disposed above the cage member;
a moving member disposed at the rail member and configured to move along a longitudinal direction D1 of the rail member;
a scanner connected to the moving member and configured to measure biometric information of the livestock; and
a driving unit configured to move the moving member and a cable connected to the scanner along the longitudinal direction D1,
wherein the rail member comprises:
a rail body; and
a linear room formed inside the rail body and in which the moving member is disposed, and
wherein the driving unit comprises:
a first transfer unit configured to move the moving member along the longitudinal direction D1; and
a carrier chain having one end coupled to a chain link portion of the moving member and the other end fixed to a bottom surface of the linear room, and configured to move the cable connected to the scanner along the longitudinal direction D1.

2. The biometric scanning system for livestock according to claim 1, wherein the driving unit further comprises a control box connected to an end of the rail member and having a box hole in communication with an interior of the rail member, the control box being configured to house, inside its interior, a controller connected to the cable,
wherein the first transfer unit is disposed inside the control box and inside the rail member, and
wherein the cable is connected between the controller and the scanner.

3. The biometric scanning system for livestock according to claim 2, wherein the first transfer unit comprises:
a motor disposed inside the control box;
a first driving pulley disposed inside the control box and connected to a drive shaft of the motor; and
a second driving pulley disposed inside the rail member; and
a timing belt connected in a form of caterpillar tracks between the first driving pulley and the second driving pulley,
wherein a belt link portion of the moving member is coupled to the timing belt.

4. The biometric scanning system for livestock according to claim 3, wherein the rail member further comprises:
a rail wall portion protruding inward from an interior of the rail body;
an upper belt room formed inside the rail body and configured to receive an upper timing belt, which is an upper portion of the timing belt having the form of caterpillar tracks; and
a lower belt room recessed in a width direction D2 into the rail wall portion and configured to receive a lower timing belt, which is an lower portion of the timing belt having the form of caterpillar tracks,
wherein the lower belt room is disposed below the upper belt room, and the belt link portion is inserted into the lower belt room.

5. The biometric scanning system for livestock according to

4. wherein the first transfer unit further comprises a position adjustment unit disposed inside the control box and configured to adjust a vertical position of the timing belt,
wherein the position adjustment unit is configured to prevent the timing belt from contacting inner surfaces of the upper belt room and the lower belt room, respectively, by adjusting the vertical position of the timing belt.

6. The biometric scanning system for livestock according to claim 5, wherein the position adjustment unit comprises:
a position adjustment hole formed through the control box in a vertical direction D3;
a position adjustment block disposed at the position adjustment hole;
a position adjustment fastener configured to adjust a vertical position of the position adjustment block on the position adjustment hole;
a first adjustment pulley disposed on the position adjustment block and configured to support the upper timing belt; and
a second adjustment pulley disposed below the first adjustment pulley on the position adjustment block and configured to support the lower timing belt.

7. The biometric scanning system for livestock according to claim 3, wherein the first transfer unit further comprises a tension adjustment unit disposed inside the control box and configured to adjust tension of the timing belt.

8. The biometric scanning system for livestock according to claim 7, wherein the tension adjustment unit comprises:
a tension adjustment hole formed through the control box in a vertical direction D3;
a tension adjustment block disposed at the tension adjustment hole;
a tension adjustment fastener configured to adjust a vertical position of the tension adjustment block on the tension adjustment hole; and
a tension adjustment pulley disposed on the tension adjustment block and configured to apply tension to the timing belt,
wherein the tension adjustment pulley is movable in the vertical direction D3 to adjust the tension of the timing belt.

9. The biometric scanning system for livestock according to claim 1, wherein the carrier chain comprises:
a chain body including a first chain piece in which a link hole is formed, and a second chain piece in which a link protrusion is formed;
a first chain coupling portion connected to the chain body and coupled to the chain link portion;
a second chain coupling portion connected to the chain body and coupled to a bottom surface of the linear room;
a plurality of cable fixing beams connected to an end of the second chain coupling portion and extending along the longitudinal direction D1, the plurality of cable fixing beams being spaced apart at predetermined intervals along a width direction D2;
a cable fixing hole formed between the plurality of cable fixing beams; and
a cable fixing protrusion protruding in the width direction D2 from an end of each of the plurality of cable fixing beams,
wherein the cable passes through the cable fixing hole, and the cable fixing protrusion presses an upper portion of the cable so that the cable is in close contact with the bottom surface of the linear room.
